(19) United States
(12) Patent Application Publication
(10) Pub. No.: US 2012/0239556 A1
(43) Pub. Date: Sep. 20, 2012

(54) LATENCY PAYMENT SETTLEMENT APPARATUSES, METHODS AND SYSTEMS

(76) Inventors: Andrew M. Magruder, Loveland, OH (US); Lex N. Bayer, Menlo Park, CA (US)

(21) Appl. No.: 13/278,148

(22) Filed: Oct. 20, 2011

Related U.S. Application Data
(60) Provisional application No. 61/455,325, filed on Oct. 20, 2010.
(60) Provisional application No. 61/431,775, filed on Jan. 11, 2011.

(51) Int. Cl. G06Q 20/22

(52) U.S. Cl. 705/39

(57) ABSTRACT

The LATENCY PAYMENT SETTLEMENT APPARATUSES, METHODS AND SYSTEMS (“LPS”) transforms latency payment request inputs via LPS components into latency payment requests. In one embodiment, a method is disclosed comprising obtaining a latency payment method request and determining a latency payment period associated with the latency payment method request. The method includes determining a consumer item currency amount by applying a currency conversion factor to the merchant item currency amount. The method also determines a latency buffer amount based on the latency payment method request, generates a latency payment request by summing the latency buffer amount to the consumer item currency amount and structuring the summed amounts according to the patency payment period, and provides the latency payment request. In some embodiments LPS may determine the latency payment request according to maximized remittance aspects associated with a consumer specified payment method so as to optimize system wide remittance results.

### PRIORITY CLAIM

Applicant hereby claims priority under 35 USC §119 for U.S. provisional patent application Ser. No. 61/455,325, filed Oct. 20, 2010, entitled “System and method for currency exchange management of variable latency payment processor” and U.S. provisional patent application Ser. No. 61/431,775, filed Jan. 11, 2011, entitled “Universal Value Exchange Apparatuses, Methods and Systems.”

This application for letters patent disclosure document describes inventive aspects directed at various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations are directed generally to an apparatuses, methods, and systems of payment transaction, and more particularly, to LATENCY PAYMENT SETTLEMENT APPARATUSES, METHODS AND SYSTEMS.

### BACKGROUND

Numerous online e-commerce sites operate internationally. These sites obtain orders from consumers and deliver goods and services both electronically and physically. These online entities typically obtain payment through credit cards.

### BRIEF DESCRIPTION OF THE DRAWINGS

The accompanying appendices and/or drawings illustrate various non-limiting, example, innovative aspects in accordance with the present descriptions:

FIGS. 1A-1D show block diagrams illustrating example embodiments of the LPS;

FIG. 2 shows a data flow diagram illustrating example LPS data flows between affiliated entities within one embodiment of the LPS;

FIG. 3A shows a logic flow diagram illustrating LPS component work flows in an embodiment of the LPS;

FIG. 3B shows a logic flow diagram illustrating latency period component work flows in an embodiment of the LPS;

FIG. 3C shows a logic flow diagram illustrating buffer cost component work flows in an embodiment of the LPS;

FIG. 3D shows a logic flow diagram illustrating overpayment-underpayment component work flows in an embodiment of the LPS;

FIG. 3E shows a logic flow diagram illustrating exercise buffer component work flows in an embodiment of the LPS;

FIGS. 4A-4B show block diagrams illustrating exemplary aspects of transforming value equivalent exchange instructions in some embodiments of the LPS;

FIG. 5A-5C show data flow diagrams illustrating example universal value exchange data flows within one embodiment of the LPS;

FIG. 6 shows a logic flow diagram illustrating exemplary aspects of transforming value equivalent exchange instructions into cross-ecosystem currency exchanges in some embodiments of the LPS; and

FIG. 7 shows a block diagram illustrating embodiments of a LPS controller.

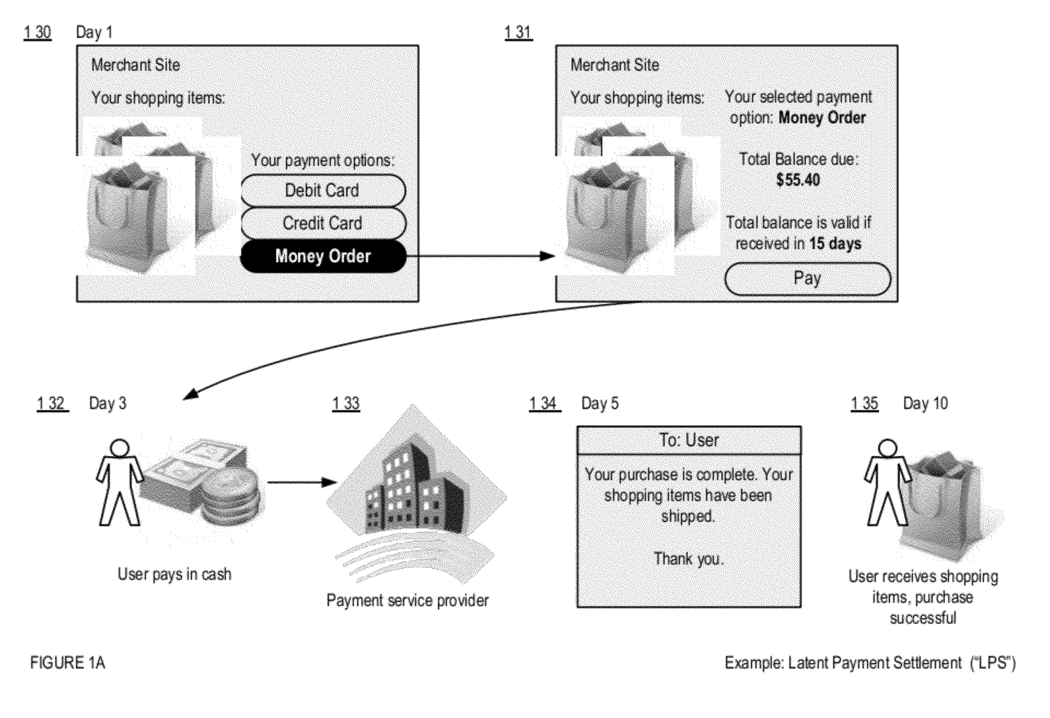

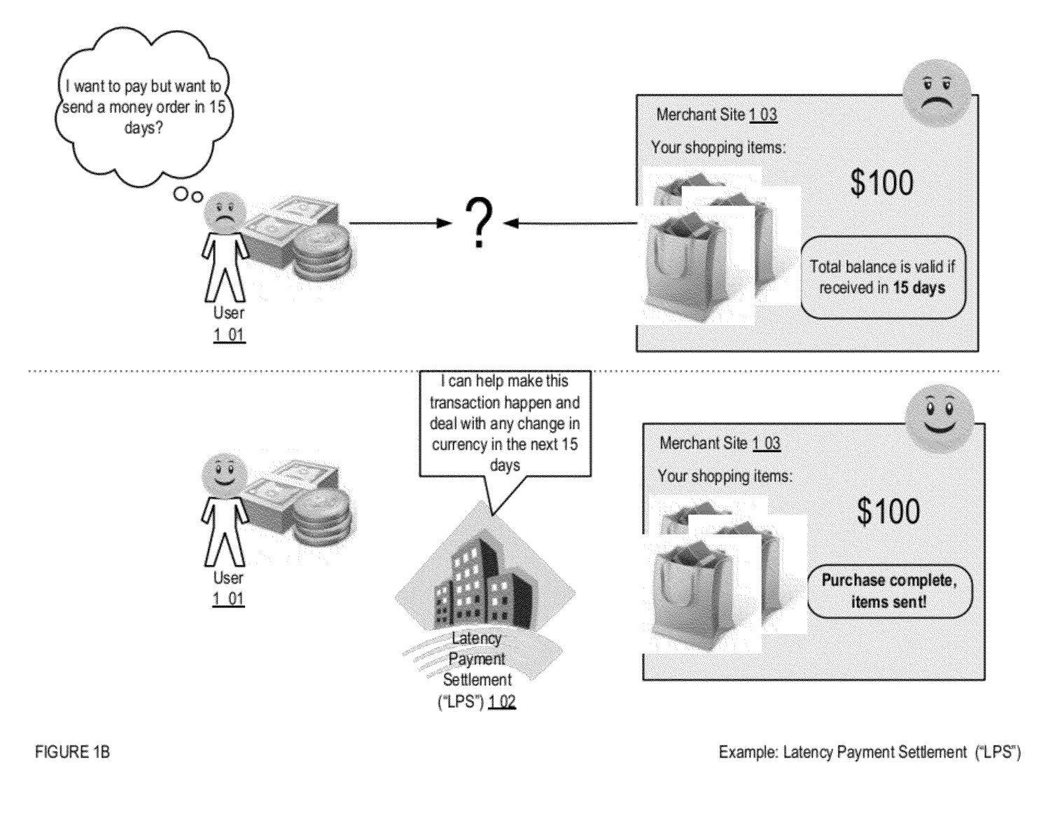

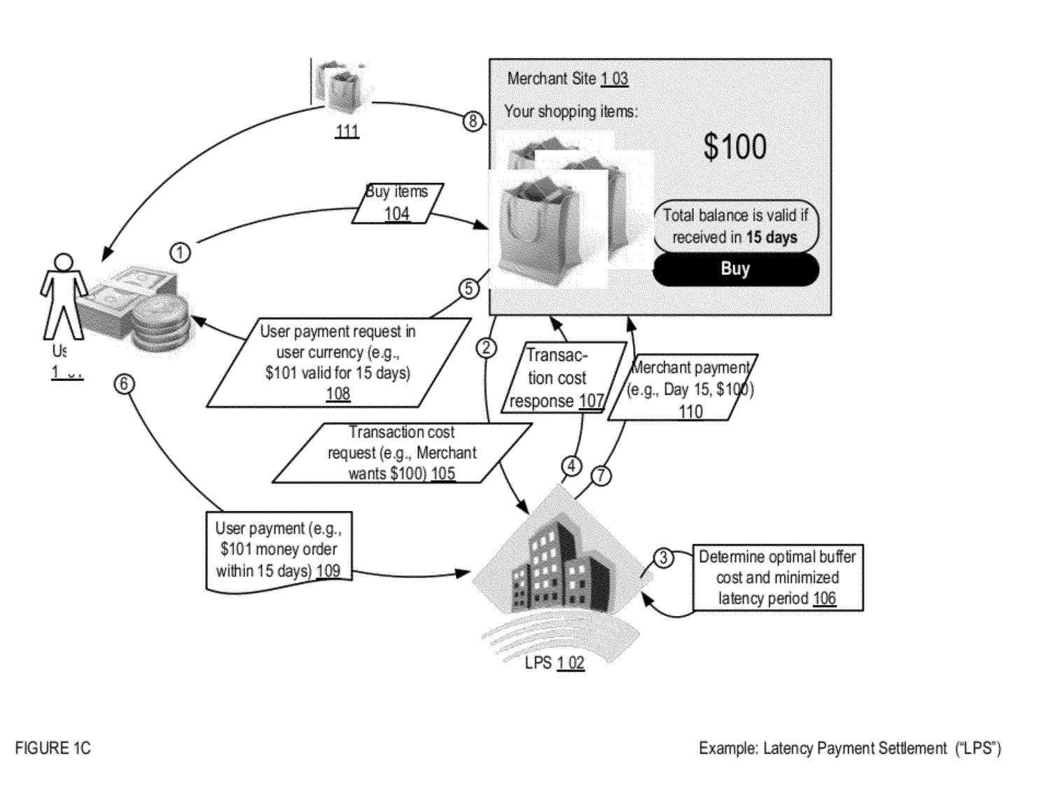

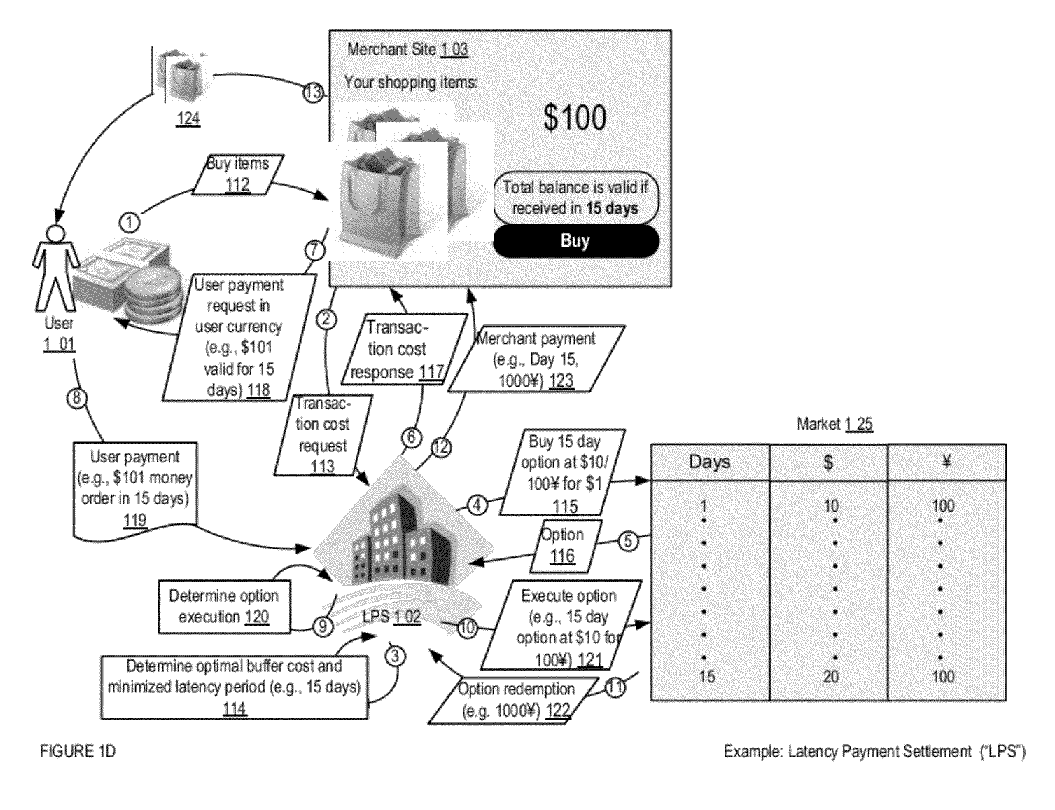

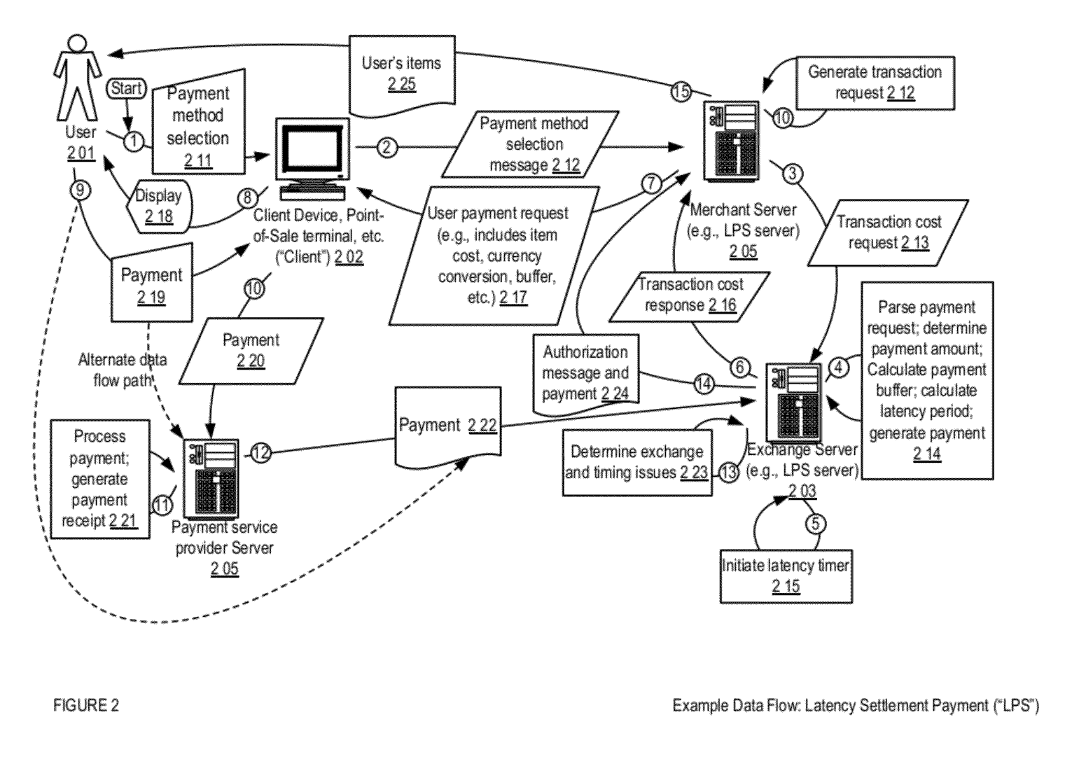

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The LATENCY PAYMENT SETTLEMENT APPARATUSES, METHODS AND SYSTEMS (hereinafter “LPS”) a latency payment platform that allows merchants to optimize the timing of receiving payments from consumers (e.g., users) that may employ various payment methods when making a purchase. Also, the LPS allows merchants to provide and consumers to utilize various currency types and high latency payment methods (e.g., slow-to-redeem payment methods), which can help protect a merchant from any risk and uncertainty associated with processing various currency types and high latency payment methods (i.e., money orders, Western Union, voucher systems (e.g Boleto bancario see http://thebrazilbusiness.com/article/boleto-bancario-for-beginners), prepaid cards, etc.), and provides a user with a quoted amount (i.e., transaction cost, etc.) that is valid for an optimal fixed period of time (e.g., latency payment period). In some embodiments the LPS may determine the quoted amount valid for an optimal fixed period of time such that a user has a maximized motivation/potential to timely and successfully carryout remittance without overpayment while simultaneously minimizing the merchant's wait time to receive payments from users. In some embodiments, the aforementioned minimizing and maximizing may be executed in response to a consumer's selected payment method.

Some merchants may want to collect payments employing additional payment methods that do not allow real-time currency conversions at the time of the transaction; often because these payment methods have high latency between the purchase and the settlement of funds and because the settlement amounts may often be precisely determined after the customer has actually completed their payment.

For example, in one implementation payments may be managed by representing a purchase price to a user in the form of a quoted amount that is valid for a fixed period of time. The transaction costs, payment request amount, as well as transaction validity (e.g., latency payment period) may be calculated according to a number of parameters including the expected latency of the payment method, the volatility of the currency and several others parameters. Payments that meet the payment request and transaction validity period may be credited to merchants and the purchases may be complete. For overpayments of the transaction amount, the overpayment value may be stored in a user's electronic wallet (i.e., virtual currency(ies), user stored balance, user virtual wallet, etc.) and processed on subsequent transactions. For underpayments, a new quote may be created for the user until the required balance is paid and then the transaction may be completed. In some embodiments, the each underpayment may be stored the user's electronic wallet.

Within embodiments, the LPS may provide a merchant with a desired outcome/settlement of funds based on an amount and currency that may be specified by the merchant, in the currency that the merchant may expect. In such embodiments, the LPS may isolate the merchant from any issues related to managing currency exchange rate risk over time, and/or any issues related to managing a consumer's payment method selection and associated risks over time. Furthermore, some embodiments of the LPS allow a full suite of payment method options extending beyond payment method options that solely support real-time payment. Within embodiments, the LPS may allow the merchant's consumer (e.g., user) to choose from a suite of payment method options (i.e., money order, credit, debit, check by mail, etc.), which may support payment in currencies other than the merchant's price currency (e.g., yen, Euros, pesos, etc.), have high latency for the customer's payment to be received (i.e., money order, Western Union, voucher systems, BillMeLater, etc.), allow payment in currencies other than anticipated (i.e., BitCoin, airline rewards, credit card rewards, virtual currencies, etc.), and/or have high latency for due to physical transmittal of funds (i.e., check by postal mail delivery, etc.) as a result of the consumer's selected payment method.

With embodiments, the LPS may ensure that a merchant is not exposed to any of the necessary complexity to achieve a desired outcome. Embodiments of the LPS allow merchants to pass customers to payment processing with a price in the currency of the merchant's choosing and allows merchants to know immediately how much they will receive as a settlement, even if the settlement currency is different than the merchants' currency, and/or if the customer pays in a third currency, and/or if the customer selects a high latency payment method.

Within some embodiments, the LPS may manage currency exchange risk with three primary components: business rules, processes, and technical systems and software to support those rules and processes. Managing the risk associated with currency exchange changes may involve modeling the costs associated with a transaction including the following factors: duration to receive a settlement, transaction processing costs, required margin, the business terms specific to the merchant and the payment system in use, typical currency volatility and typical settlement times for the various payment methods. In some embodiments, the technical implementation of these rules may provide transaction-level control to manage risk exposure on a per transaction basis based on the characteristics of each individual transaction (i.e., consumer's payment method selection, transaction amount, transaction currencies, etc.).

In some embodiments of the LPS the merchant may pass to the payment provider a required collection amount and merchant specified currency. In such an embodiment the LPS may use that merchant's required collection amount together with a calculation based on the risk management transaction level parameters described in previous embodiments to generate a transaction amount that may be presented to the customer and a corresponding latency payment period for how much the customer may need to pay and in what currency and by when. In some embodiments this transaction amount may have a limited period of validity (e.g., latency payment period, etc.) based on the characteristics of the transaction (i.e., customer's payment method selection, etc.). The following is an example of how the LPS may generate a transaction amount for an example user: A merchant wants to collect $10 in US currency, and the user selects to pay via Western Union in yen. The LPS calculates based on historic data that a Japanese Western Union payment takes on average $10 days to settle. The system calculates based on historic data that yen has a volatility band of 0.015% over a ten-day period. Also included in the calculation are the processing costs charged by Western Union, risk factors associated with the Western Union order from Japan, and the margins of the payment processor. Combining the various factors, the LPS may generate a transaction amount that may minimize the expected foreign currency exchange risk and may present that transaction amount to the user with some added buffer on the transaction validity (e.g., latency time period). The payment provider may then honor that transaction amount. Due to a high volume of transactions flowing through the LPS, the LPS may average out any minor fluctuations in foreign exchange.

Further to the example, once the customer's payment is received, the LPS may utilize established and/or predefined business processes to ensure that the currency exchange related costs and payment method costs are properly managed. In the case of sufficient payment, the customer's payment may be converted into a settlement amount and a currency that the merchant either expects or has previously defined/requested.

However, further to the same example, if a payment arrives beyond the transaction validity period, the LPS may recalculate the transaction cost based on current exchange rates. At this point, the customer may be responsible for bearing the additional currency exchange related costs and payment method costs because their payment was late and the customer is presented with a new transaction amount via email or when they login to the merchant's website or payment system. Embodiments of the LPS may incorporate any additional costs and late fees into regenerated user payment requests. In some embodiments, payments received beyond the transaction validity period may also be stored under the customer's virtual wallet until full payment is achieved, and/or for use in other transactions.

In some embodiments, the LPS may utilize an electronic wallet (i.e., virtual currency(ies) user stored balance, user wallet, etc.) to manage cases of overpayment and underpayment. Further, the LPS may use the electronic wallet or virtual currency(ies) to hold funds in the interim before release to the merchant. In some embodiments, the LPS may not release funds to the merchant until the customer has resolved underpayment (e.g., paid sufficient funds to cover the settlement obligation to the merchant, the payment systems transaction processing costs, and the minimum required margin for that transaction, which as stated previously may be iteratively summed in a regenerated user payment request after each instance of underpayment).

Some embodiments of the LPS may further include a matching and calculation system. The LPS may provide a dynamic rate matching system and database for any type of rate or fee required. This rate matching system and database may be used to store and calculate the necessary transaction costs (i.e., payment method costs, etc.) and validity periods (e.g., latency periods, etc.) to ensure sufficient funds will be received from a customer to cover a settlement obligation to a merchant. Embodiments of the LPS may provide rate matching based on the category of a merchant or payment system, a currency of the truncation, a transaction amount, a specific merchant and/or a payment system in use. Such embodiments of the LPS may utilize a best-match algorithm technique on the characteristics of each specific transaction and may output a full set of pricing data including the amount to be settled to the merchant upon receipt of the customer's payment.

### LPS

FIGS. 1A-1D show a block diagram illustrating example embodiments of the LPS. As shown in FIG. 1B, a user may wish to buy an item, e.g., light bulb, with US dollars and may want to send money to cover the cost of the item in 15 days. At the same time, a merchant providing the items, e.g., light bulb, for sale may only be able to receive payment in the form of yen, although the merchant may present its desired payment in the user's currency (i.e., US dollars, etc.). FIG. 1B shows an inability by the merchant and the user to complete the transaction. However, FIG. 1B also shows a successful transaction execution between the user the merchant due to the introduction of an LPS platform which may help execute the payment within the validity period (e.g., latency period, 15 days, etc.) defined by the merchant and identified by the user, and may shoulder the risk associated with payment latency and currency exchange risks. It should be noted, that the LPS may also enable high latency transactions where no currency conversion/exchange is required as well.

FIG. 1C shows a user requesting to buy items provided by a merchant, and the merchant's interaction with LPS to facilitate the entire payment transaction. Although FIG. 1C and others throughout show examples of high-latency transactions that include currency conversions, it should be understood, that the LPS may frequently be used for transactions in a single currency, i.e., requiring no currency conversions, and as such, the currency conversion components may be considered optional.

FIG. 1C shows an example implementation where once the payment request to buy has been received 104 by the merchant 103 from the user 101, the merchant transmits a cost request to the LPS 105. The LPS may receive and use the cost request to determine an optimal buffer cost 106 based on the transaction's details and the latency payment period such that user is most likely to pay in a timely manner and such that the merchant has a minimized wait time. The LPS may transmit the buffer cost and latency payment period (i.e. 15 days) back to the merchant 107 which may then transmit the request to the user in the user's currency (i.e., $101, etc.) 108. After some time within the 15 day window stipulated by the merchant and/or by the LPS (e.g., latency payment period, payment validity period, etc.), the user provides payment to the LPS (e.g., $101) 109 which handles processing of the payment, deducts the buffer costs, and credits/transmits payment to the merchant (e.g., $100) 110. Once received the merchant may release the customer's requested items to the customer 111.

Again, although FIG. 1D and others throughout show examples of high-latency transactions that include currency conversions, it should be understood, that the LPS may frequently be used for transactions in a single currency, i.e., requiring no currency conversions, and as such, the currency conversion components may be considered optional.

Similarly, FIG. 1D shows a user 101 requesting to buy items 102 provided by a merchant 103, the merchant's interactions with the LPS (e.g., 113, 117, and 123), the user's interaction the LPS (e.g., 119), and the LPS's processing of payments, however FIG. 1D shows exemplary protective measures (i.e., buffer determination, etc.) the LPS executes which include acquisition of an option (e.g., 114, 115, and 116) to hedge against potential changes in the currency exchange rate over periods of time. For example, once the LPS receives the transaction cost request from the merchant 113, the LPS determines a optimal buffer costs and a minimized latency period 114, both associated with the transaction. The LPS may request from the market an option for a currency exchange pairing of $10 to 100 yen, at the cost of $1, where the $1 is dictated according to the determined optimal buffer cost 115. Once the option is received from the market 116, the LPS totals all costs and transmits to the merchant the total cost of the transaction (i.e., transaction amount, transaction cost quote, etc.) and the latency period 117, which may then be transmitted to the user in the user's currency (e.g., $101) 118. Once the payment is received from the user 119, the LPS determines whether to execute the purchased option or not 120. If executed 121, the LPS receives the option redemption 122 from the market 125, deducts processing costs, and transmits the difference (e.g., the merchant payment) to the merchant (e.g., 1000 yen) 123.

FIG. 2 shows a data flow diagram illustrating example LPS data flows between affiliated entities within one embodiment of the LPS. In some implementations, a user, e.g., 201 may provide a payment method selection (i.e., credit, debit, money order, virtual currency, etc.) to a client device, e.g., 202, which may generate payment selection message and transmit said message 212 to a merchant server, e.g., 205. The merchant server may then transmit a transaction cost request to an exchange server (e.g., LPS server) where the transaction cost request may be parsed 214 to determine the user location, the merchant location, the transaction amount requested by the merchant, and restrictions defined by the merchants and/or referenced in a merchant historical record database. Parsing the request may also be done by the LPS to determine the source currency type defined by the user and the requested currency type defined by the merchant. The LPS may calculate a payment buffer and latency period based on the parsed transaction request data. The LPS may generate a payment comprising all costs calculated by the LPS inclusive of exchange rate costs, buffer costs, transaction processing fees, projected payment service provider fees, and/or the like. Once generated the LPR may initiate a latency period timer, set in accordance to the calculated latency period, and may simultaneously transmit a transaction cost response 216 back to the merchant. Once received, the merchant may then generate and transmits a user payment request to the user. The user payment request may include the item cost, the transaction costs provided by the LPS, currency conversion, an effective latency period (e.g., the latency period according to the initiated latency timer), and/or the like 217. The client 202 may display or provide the user payment request to the user 218.

In some implementations, the user may provide the payment via the client device 202 which may then be transmitted to a payment service provider 205. However in other implementations, the user may direct provide the payment to the payment service provider 205. Furthermore, in some implementations the user may provide payment direct to the exchange server 203. With regard to the payment being received by the payment service provider 205, the payment service provider may process the payment and generate a payment receipt 221. Once generated the payment service provider 205 may transmit the payment to the exchange 222 where the exchange may determine exchange and timing issues 223 which may include determining the current exchange rate, determining buffer exercise options, and determine latency period timing issues. Again, although FIG. 2 and others throughout show examples of high-latency transactions that include currency conversions, it should be understood, that the LPS may frequently be used for transactions in a single currency, i.e., requiring no currency conversions, and as such, the currency conversion components may be considered optional. Nevertheless, with regard to the determining a current exchange rate the exchange may access market data records and/or market data feeds associated with relevant currency exchange rate. The exchange 203 may either authorize or decline the transaction. If the exchange 203 authorizes the transaction, the exchange may transmit a message to the merchant authorizing the transaction and providing the payment 224. If the exchange is declined decline/error message may transmitted to the user and/or the merchant. In some implementation such a decline/error message may include a regenerated payment request determined by the exchange to cover incomplete transaction costs, incomplete payments, late payments, defaulted payments, and/or the like.

If the transaction is authorized and payment is transmitted to the merchant 224, the merchant 205 may process the payment and release the user's purchased/requested items to the user. Said release may be executed with a receipt of the transaction, the user's current transaction history (i.e., exchange rates, processing costs, payment iterations, timing issues, etc.), and in some embodiments the receipt may include a balance of the user's virtual currency account. In some embodiments, of the LPS, if the payment received by the exchange 222 is more than requested/required (e.g., overpayment), the exchange may credit the difference to the user's predefined or instantly defined virtual currency account which may be accessed by the user and/or the LPS in future transactions by/for the user.

The above-described LPS process may generate a payment method selection, e.g., 211, whereby, for example, a client or server computer, e.g., 202, may receive a HTTP(S) POST message similar to the example below:

```
POST /user_purchase.php HTTP/1.1
Host: www.PDRprocess.com
Content-Type: Application/XML
Content-Length: 788
<?XML version = “1.0” encoding = “UTF-8”?>
<PaymentMethodSelection>
<timestamp>2011-02-22 17:00:01</timestamp>
          <user_information>
                <user_ID>1234JS23</user_ID>
                <user_name>John Smith</user_name>
                <user_account_type>credit</user_account_type>
                <user_address> 420 E 100th Street,
                NY, 10022</user_address>
          </user_information>
          <payment_params>
                <payment_id>3FBCR4INC</payment_id>
                <payment_name>Western Union</payment_name>
                <payment_type>money order</payment_type>
                <payment_Location>Manhattan
                10022</payment_Location>
                <payment_usercurrency>USD</
                purchase_usercurrency>
          </payment_params>
</PaymentMethodSelection>
```

The above-described LPS process may also generate a request for transaction cost, e.g., 213, whereby, for example, the exchange server, e.g., 203, may receive a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<transactionCost_request>
<timestamp>2011-02-22 17:00:01</timestamp>
          <user_account_params>
                <user_account_ID>1234567JS</ user_account_ID>
                <account_name>John Smith</account_name>
                <account_type>credit</account_type>
                <account_num>123455789012345</account_num>
                <user_location>Munich Germany</user_location>
          </user_account_params>
          <merchant_params>
                <merchant_id>3FBCR4INC</merchant_id>
                <merchant_name>Apple Store</merchant_name>
                <merchant_Industry>electronic
                goods</merchant_industry>
                <merchant_Location>Tokyo</merchant_Location>
                <purchase_price>599</purchase_price>
                <merchcurrency>YEN</merchcurrency>
                <merchant_exp_threshold>15
                days</merchant_exp_period>
          </merchant_params>
          <userpayment_params>
                <payment_id>3FBCR4INC</payment_id>
                <payment_name>Western Union</payment_name>
                <payment_type>money order</payment_type>
                <payment_Location>Munich
                Germany</payment_Location>
                <usercurrency>USD</usercurrency>
          </userpayment_params>
          <purchase_summary>
                <num_products>1</num_products>
                <purchased_item>iPad tablet
                computer</purchased_item>
          </purchase_summary>
</transactionCost_request>
```

The above-described LPS process may also generate a transaction cost response, e.g., 216, whereby, for example, the exchange server, e.g., 203, may generate a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<transactionCost_response>
<timestamp>2011-02-22 17:00:01</timestamp>
          <merchant_params>
                <merchant_id>3FBCR4INC</merchant_id>
                <purchase_price>700</purchase_price>
                <merchcurrency>YEN</merchcurrency>
          </merchant_params>
          <userpayment_params>
                <payment_id>3FBCR4INC</payment_id>
                <payment_name>Western Union</payment_name>
                <payment_type>money order</payment_type>
                <payment_Location>Munich
                Germany</payment_Location>
                <purchase_price>20</purchase_price>
                <usercurrency>USD</usercurrency>
                <validperiod>10 days</validperiod>
          </userpayment_params>
</transactionCost_response>
```

The above-described LPS process may also generate a user payment request, e.g., 217, whereby, for example, the merchant server, e.g., 205, may generate a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<payment_request>
<timestamp>2011-02-22 17:00:01</timestamp>
          <merchant_params>
                <merchant_id>3FBCR4INC</merchant_id>
                <merchant_name>Apple Store</merchant_name>
                <merchant_Industry>electronic
                goods</merchant_industry>
                <merchant_Location>Tokyo</merchant_Location>
                <purchase_price>700</purchase_price>
                <merchcurrency>YEN</merchcurrency>
          </merchant_params>
          <userpayment_params>
                <payment_id>3FBCR4INC</payment_id>
                <payment_name>Western Union</payment_name>
                <payment_type>money order</payment_type>
                <payment_Location>Munich
                Germany</payment_Location>
                <purchase_price>20</purchase_price>
                <usercurrency>USD</usercurrency>
                <validperiod>10 days</validperiod>
          </userpayment_params>
</payment_request>
```

The above-described LPS process may also generate a user payment, e.g., 219, 220, 222, whereby, for example, the exchange server, e.g., 205, may receive a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<User_Payment>
<timestamp>2011-02-22 17:00:01</timestamp>
          <payment_params>
                <payment_id>3FBCR4INC</payment_id>
                <payment_name>Western Union</payment_name>
                <payment_type>money order</payment_type>
                <payment_Location>Munic
                Germany</payment_Location>
                <payment_amount>20</payment_amount>
                <usercurrency>USD</usercurrency>
          </payment_params>
</User_Payment>
```

The above-described LPS process may also generate an authorization message along with payment, e.g., 224, whereby, for example, the merchant server, e.g., 205, may receive a HTTP(S) POST message similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<Authorization_payment>
<timestamp>2011-02-22 17:00:01</timestamp>
          <Authorization_summary>
                <authorization_id>3ABCF4POS</autorization_id>
                <authorization>YES</autorization>
          </Authorization_summary>
          <payment_params>
                <payment_id>3FGH4CV</payment_id>
                <payment_name>DirectTransfer</payment_name>
                <payment_type>electronic</payment_type>
                <payment_amount>599</payment_amount>
                <merchcurrency>YEN</merchcurrency>
          </payment_params>
</Authorization_payment>
```

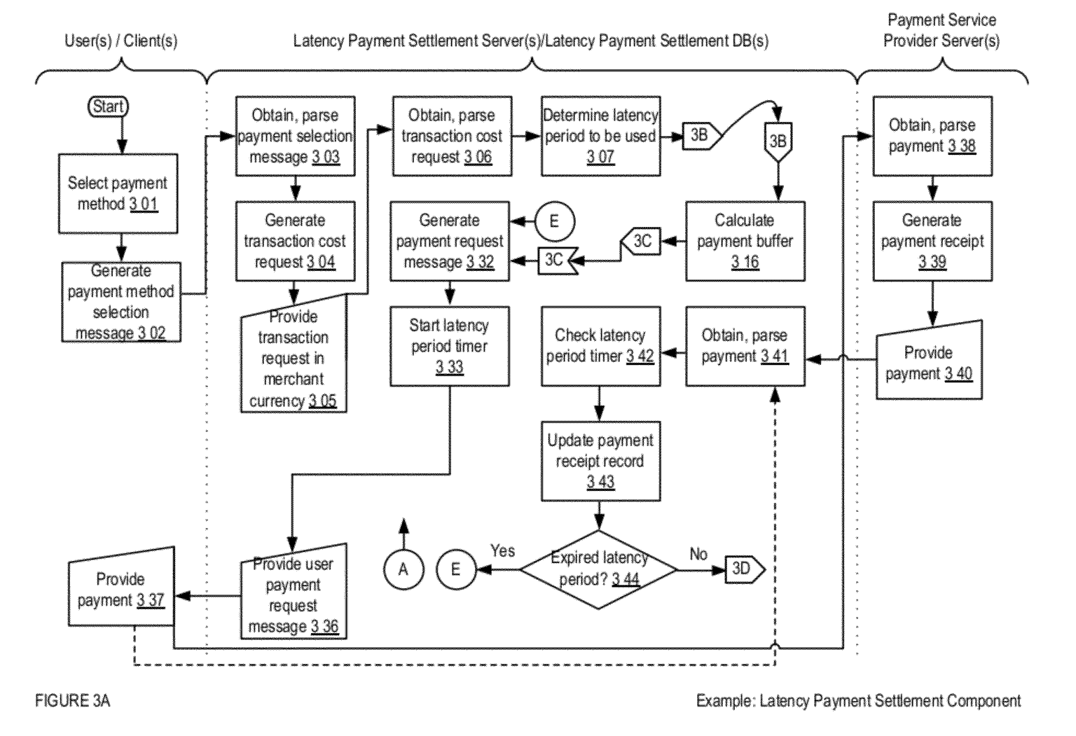

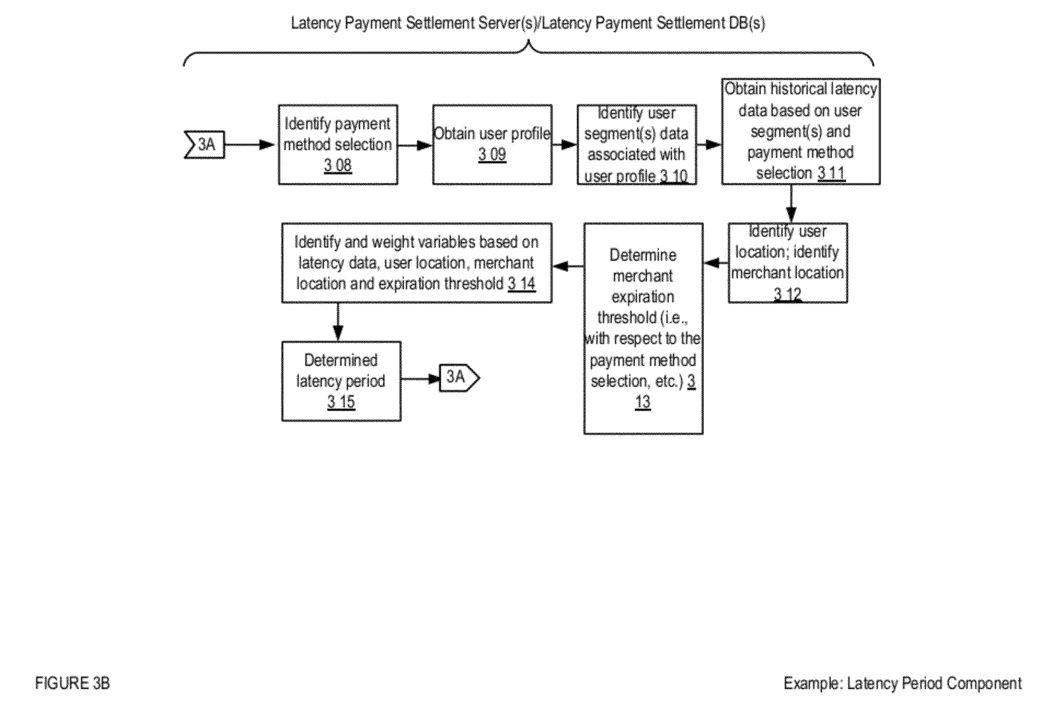

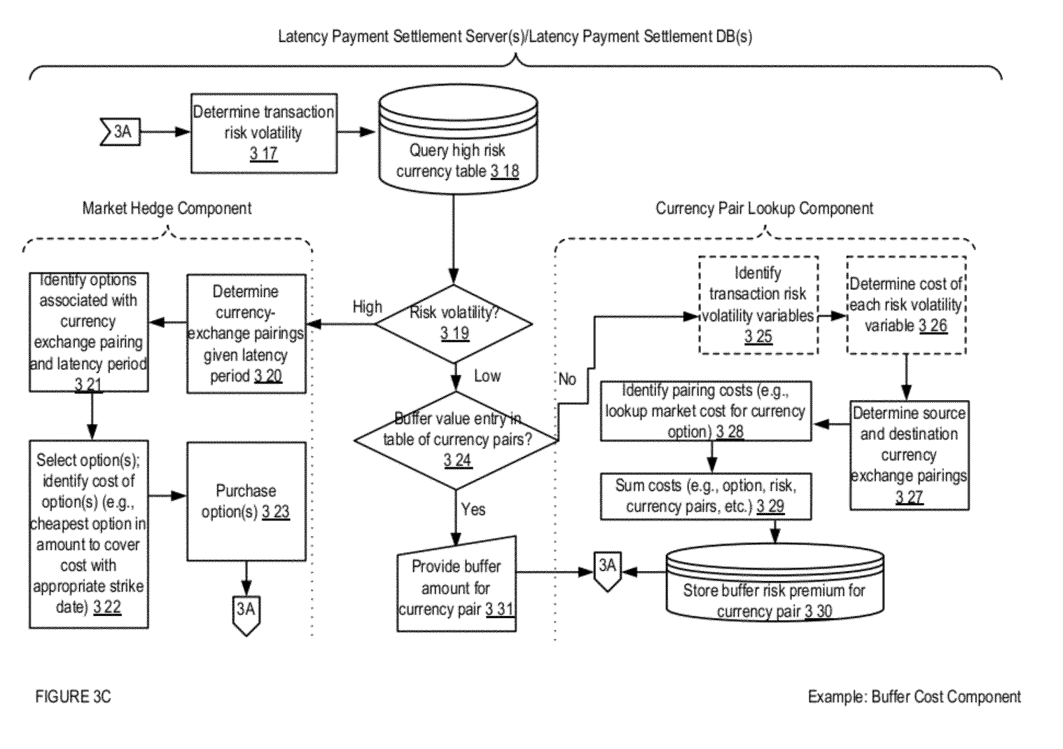

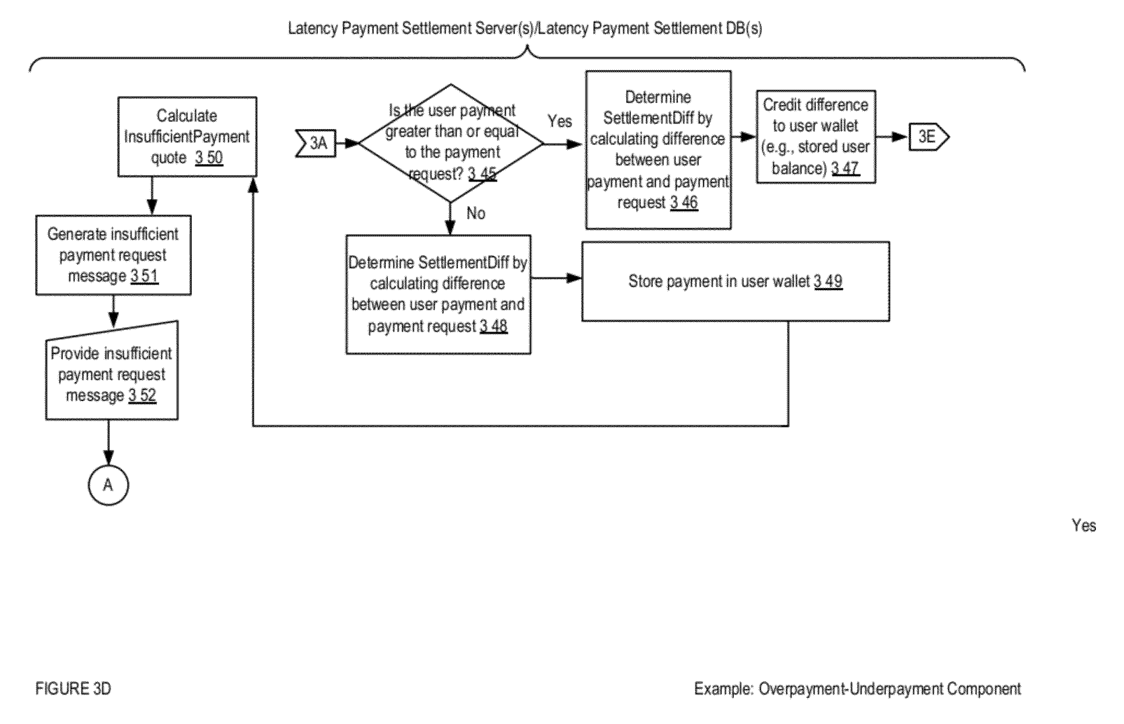

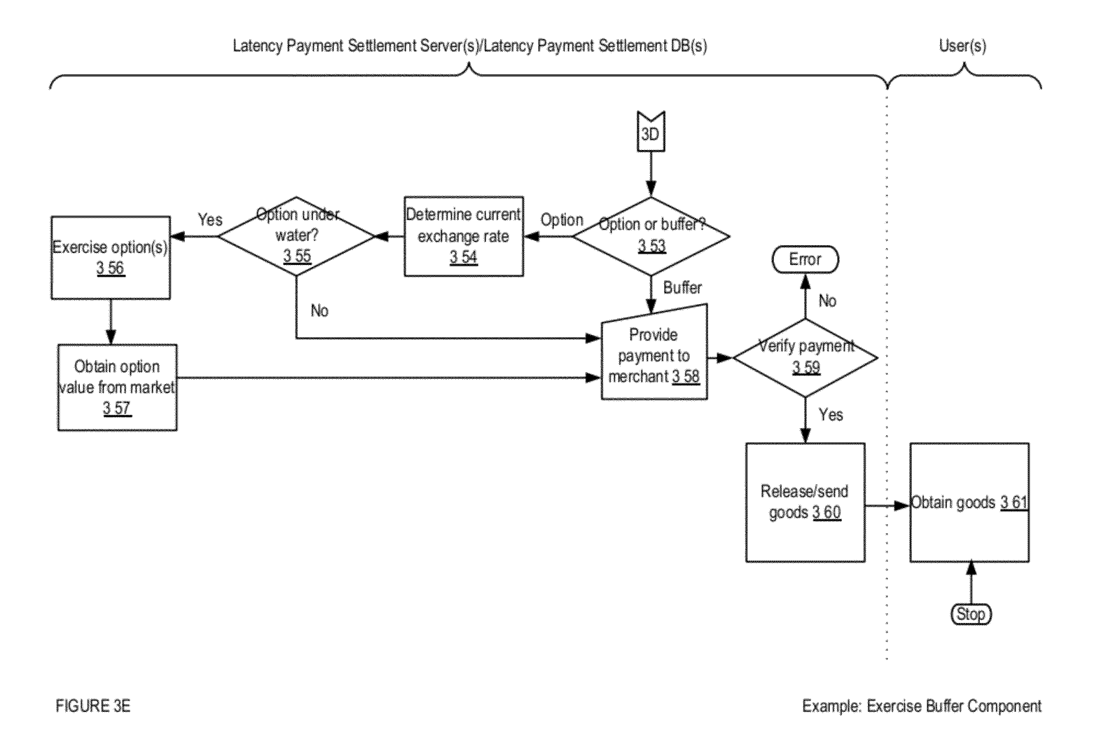

FIG. 3A-3D shows a logic flow diagram illustrating LPS component work flows in an embodiment of the LPS. In some implementations, a user may desire to purchase a product, service, offering, and/or the like (“product”), from a merchant via a merchant online site or in the merchant's store and in doing so may select a payment method 301. The interfacing client may generate a payment method selection method message 302 which may be obtained and parsed by the LPS 303. The LPS may then generate transaction cost request 304 and provide a transaction request in the LPS's identified currency 305. The LPS may obtain and parse the transaction request 306 to determine a latency period to be used in generating a user payment request 307.

In some implementations, with regard to determining the latency period, the LPS may identify the payment method selection 308, obtain a user profile to identify data associated with one or more user segments 310. The exchange may also obtain historical latency data structured according to the identified one or more user segments, taking into account the user's profile history for late payments, the users correspondent user segment(s)'s history and/or propensity to late payments, user and/or user segment(s)'s average payment times and/or the like. The obtained historical latency data may also be structured according to the selected payment method. In some embodiments the determination of latency period may be directly associated with risk tolerances derived from payment method types. The LPS may also identify the user's location and the merchant's location 313, which may be used to determine average latency periods between the two locations. For example, in some implementations, such determination of average latency periods may occur if/when a merchant defines payments to be received by a high latency payment method (i.e., money order, check, etc.) as opposed to a real-time payment option (i.e., credit, debit, etc.). The LPS may also determine a merchant expiration threshold which may designate the merchant's preferred period of payment receipt before the user's order/purchase to the merchant expires (i.e., 10 days, 12-15 days, 3 months, etc.). In some embodiments, the merchant expiration threshold may be determined from historical merchant trend data collected by LPS servers. For example, by analyzing historical records the LPS may determine clothing merchants based out of Morocco expire orders after 2 weeks from their initial order. The LPS may then structure the aforementioned historical latency data, user location data, merchant location data, and merchant expiration threshold data, according to predefined weighted values developed empirically over time. The LPS may then aggregate the values to determine the aforementioned latency period 315.

In some embodiments, once the latency period to be used has been determined the LPS may calculate a payment buffer cost 316. In preparation of calculating the payment buffer cost the LPS may determine transaction risk volatility 317 and may query a high risk currency table 318. If it is determined the risk volatility 319 is low then the buffer cost may be determined according to the Currency Pair Lookup Component. If it is determined the risk volatility 319 is high then the buffer cost may be determined according to a Market Hedge Component. With regard to the low risk volatility and Currency Pair Lookup Component, the LPS may determine first whether a buffer value entry already exists in a currency pair table for the determined currency pair (parsed previously from the transaction cost request). If the buffer value exists then the LPS may provide the buffer value amount for the currency pair in the LPS's generation of the payment request message 332. Although, if the buffer value does not exist then the LPS may parse the determined transaction risk volatility to identify transaction risk volatility variables 325, which may be variables that define transaction risk volatility (i.e., transaction amount, transaction request source, transaction request destination, user history, payment method selection, etc.). The LPS may determine costs associated with each risk volatility variable from historical databases 326, including processing costs associated with each risk volatility variable (i.e., payment method selection, etc.). The LPS may determine source and destination currency exchange pairings 327 and identify costs of said pairings 328. The LPS may sum all identified and determined costs to produce a buffer cost amount which the LPS may store 330 as a buffer risk premium correspondent with the currency pair to be used in the generation of the payment request message 332.

Again, although FIG. 3 and others throughout show examples of high-latency transactions that include currency conversions, it should be understood, that the LPS may frequently be used for transactions in a single currency, i.e., requiring no currency conversions, and as such, the currency conversion components may be considered optional.

If the risk volatility 319 is determined to be high the LPS may determine currency exchange pairings at or in relation to the determined latency period 320. The LPS may then identify an array of options based on the currency exchange pairings and the determined latency period 321. In one embodiment where risk and volatility is higher, the LPS may purchase enough options to cover a total loss, i.e., enough to provide the merchant with payment even in a scenario where the consumer's provided payment has lost all value. In another embodiment, the LPS may determine a percentage of the merchant value as likely to be covered by the consumer provided payment (i.e., the consumer's currency payment will likely cover 50% of any transaction due to the merchant). The LPS may add a third value to the currency exchange pairing table to include percentage cover value that may be used in determining the amount of options to buy on the market (i.e., if there is confidence that the consumer provided payment/currency amount will cover 50% of what is due to a merchant, then options covering 50% of that value may be purchased, thereby reducing the transaction cost). The LPS may identify and select the least expensive option of the identified options given an appropriate strike price 322. The LPS may purchase the option and proceed to generate the payment request message 332.

Generation of the payment request message may be structured according the calculate payment buffer costs (e.g., option, buffer risk premium, buffer value from the table of currency pairs, etc.) 332. In some embodiments, once payment request message has been generated the LPS may start a latency period timer 333, which may be initially set according to the determined latency period. The LPS may provide the payment request message to the user 336. Upon receipt of the payment by the user, the payment service provider may parse the payment 337, 338 to generate a payment receipt 339 and provide payment to the LPS. In some embodiments the user may provide payment 337 direct to the LPS for processing 341.

In some implementations the LPS may check the latency period timer 342 and update the payment receipt record 343. If the latency period has expired 344, the LPS may cancel the transaction and store the payment in the user's LPS electronic wallet. In some implementations, if the latency period has expired 344 the LPS may regenerate the payment request message with a modified latency period. In some implementations this process may be repeated with increased restrictions on subsequently modified latency periods and/or with additional processing and late fees incorporated into the payment request message amount. If the latency period has not expired the LPS may then determine whether an overpayment or underpayment has occurred 345. If an overpayment has occurred the LPS may determine the difference between the user's payment and the payment request 346. The may credit the determined difference to the user's stored balance (e.g., user virtual wallet) 347. If an underpayment has occurred the LPS may determine the difference between the user's payment and the payment request 348, and may store the user's payment in the user's virtual wallet 349. The LPS may calculate an insufficient payment quote based upon the difference amount 352 and provide the user with an insufficient payment request message 354 in attempt to collect the remaining payment amount. In some embodiments the insufficient payment quote may be calculated to incorporate current market conditions and historical user behavior data to ensure complete and timely remittance without the user overpaying (or underpaying).

FIG. 3E shows exercise buffer determination that may take place after a user's payment has been received in full. For example, once the user's payment has been received the LPS may determine which buffer strategy/type (e.g., Market Hedge, Currency Pair Lookup, etc.) may be exercised 354. If the LPS determines the buffer risk premium 330 or buffer amount of 331 were used the LPS may deduct either buffer risk premium or buffer amount from the payment and provide remaining payment to the merchant 358. If the LPS/merchant fails to verify the payment 359 an error protocol may be initiated, which may comprise sending an error message to the user, request a review of the transaction by the LPS to determine the source of the error, and/or the like. If the LPS/merchant verifies 358 the payment the merchant may release the user's purchased items 360 361.

If the LPS determines the buffer strategy/type 353 includes an option the LPS may determine the currency exchange rate 354 by access market data and/or market feed data. The LPS may determine if the strike price and associated terms of the purchased option are higher than the current exchange rate. If the option is higher than the currency exchange rate the LPS may exercise the option 356, obtain the option value from the market 357, and provide the merchant's requested payment. If the option is not lower than the currency exchange rate the LPS may instead deduct the cost of the option from the payment and provide the remaining payment to the merchant 357.

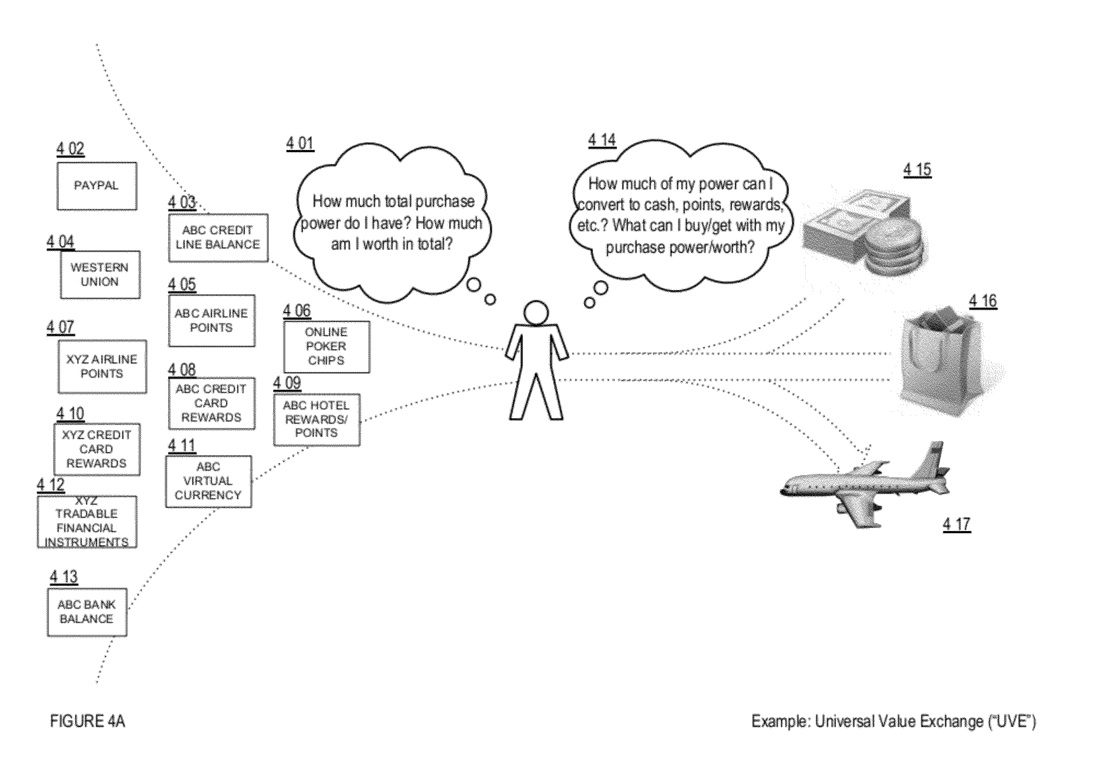

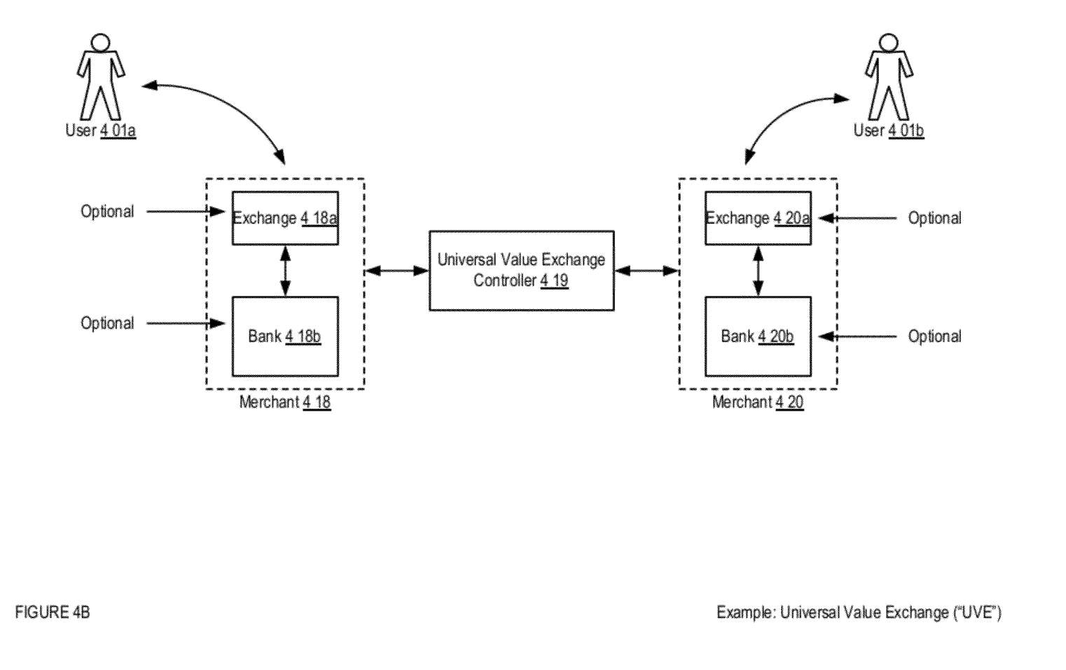

FIGS. 4A-4B show a block diagrams illustrating exemplary aspects of transforming value equivalent exchange instructions in some embodiments of the LPS. In some implementations, a user may desire to utilize purchasing power available to the user to obtain a desired product. For example, the user may be shopping online, playing a virtual online game (e.g., poker), trading on the stock market electronically, engaging in foreign exchange transactions, and/or other like transactions. In some implementations, the user may retain such purchasing power in various types of currency 402-413. In some implementations, the user may have retained purchasing power in various currency types across various ecosystems 402-413. For example, the user may have access to currencies such as, but not limited to: a financial account (checking, savings, debit card, credit card, current account, money market, etc.) storing currency of a real-world monetary system (e.g., U.S. dollar, Yen, Euro, etc.), an electronically tradable financial instrument (e.g., derivative financial products, securities, bonds, etc.), virtual currency (e.g., online poker chips, Farmville seeds, etc.), rewards program currency (e.g., rewards points, airline miles, hotel credits, rental car rewards, cruise line rewards, credit card rewards points, cash-back rewards, etc.), and/or the like. In some implementations, the user may desire to convert purchasing power available in one currency ecosystem to another currency utilized in a completely different ecosystem 414-417. As one example, the user may desire to convert points from traditional rewards programs into cash withdrawn from an ATM-linked account. As another example, the user may desire to convert rewards points from an airline miles program into virtual currency that can be utilized in an online social networking game, e.g., Farmville. As another example, the user may desire to convert virtual currency into currency usable to purchase stock on an electronic trading system. As another example, the user may desire to convert a combination of currencies from financial account(s) storing currency of a real-world monetary system, electronically tradable financial instrument(s), virtual currency(ies), rewards program(s) point(s)/mile(s)/reward(s), and/or the like into a different combination of such currencies.

In some implementations, a user may desire to aggregate purchasing power from a variety of source 401-413, and apply the purchasing power towards executing a single transaction 414-417. For example, with reference to FIG. 4B, a user 401B may desire to execute a transaction with a user 401C. In some implementations, the user 101B may communicate with user 101C to execute the transaction via a universal value exchange controller 419. In some implementations, the user may optionally communicate with intermediary merchants, exchanges, banks, and/or the like (e.g., 418, 420). For example, the user may communicate with an electronic trading system (e.g., 418a, 420a) to execute a transaction. As another example, the user may communicate with a bank (e.g., 418b, 420b) to conduct a transaction. As another example, the user may communicate with a merchant system (e.g., 418, 420) for purchasing goods and/or services. In some implementations, a user 401B may provide cross-ecosystem currency exchange instructions to the universal value exchange controller 419. For example, the user 101B, in such instructions, may specify source details (of user 401B) such as, but not limited to: currency source types, currency account numbers, currency access usernames, currency access passwords, and/or the like, as well as destination details (of user 401C) such as, but not limited to: currency destination types, currency account numbers, currency access usernames, currency access passwords, and/or the like. In some implementations, the universal value exchange controller 419 may obtain the cross-ecosystem currency exchange instructions from user 101B. The universal value exchange controller may determine the sources of currency, and determine the types of currency available at the sources of the currencies. The universal value exchange controller may determine exchange rates for each of the source currencies, for example, relative to a standard currency (e.g., U.S. dollar, Euro, Yen, privately created currency standard, and/or the like). The universal value exchange controller may also determine whether there are any restrictions or conditions at each of the sources of the currencies, as well as the destinations of the currencies. For example, a rewards points program may have a restriction against converting its rewards points into rewards points of another rewards points program; a condition that conversion can only take place if fewer than a threshold amount of rewards points are utilized, and/or the like. Each of the source currencies may have various restrictions and/or conditions on use of the currency type of the source.

In some implementations, the universal value exchange controller may obtain the restrictions and/or conditions of the sources and destinations of the currencies, and may determine a currency exchange flow path based on the restrictions and/or conditions at the currency sources and/or destinations. Upon determining a currency exchange flow path, the universal value exchange controller 419 may provide request messages to the components in the currency exchange flow path, e.g., exchanges (e.g., 418a, 420a), banks (e.g., 418b, 420b), merchants (e.g., 418, 420) and/or the like, requesting the components to provide and/or accept currency value, based on the determined currency exchange flow path. Upon completing the currency withdrawal and/or deposits into each of the currency accounts involved in the cross-ecosystem currency exchange, the universal value exchange controller may provide notifications to the users 401B, 401C notifying them of completion of the requested cross-ecosystem currency transaction.

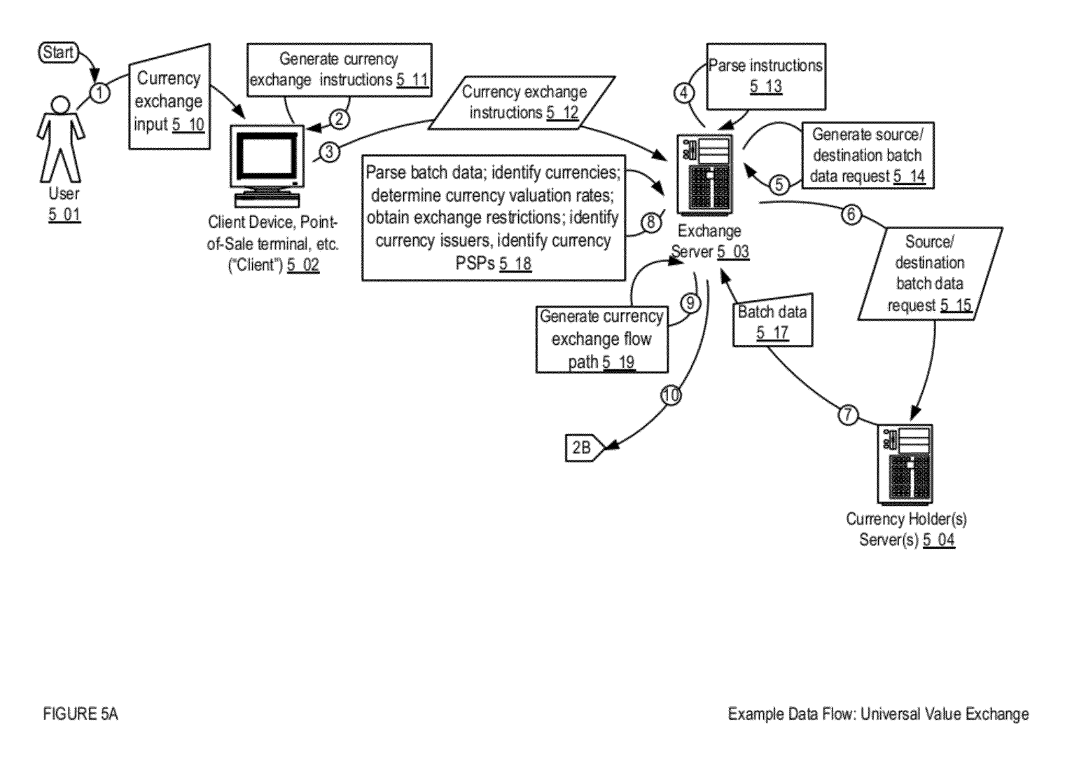

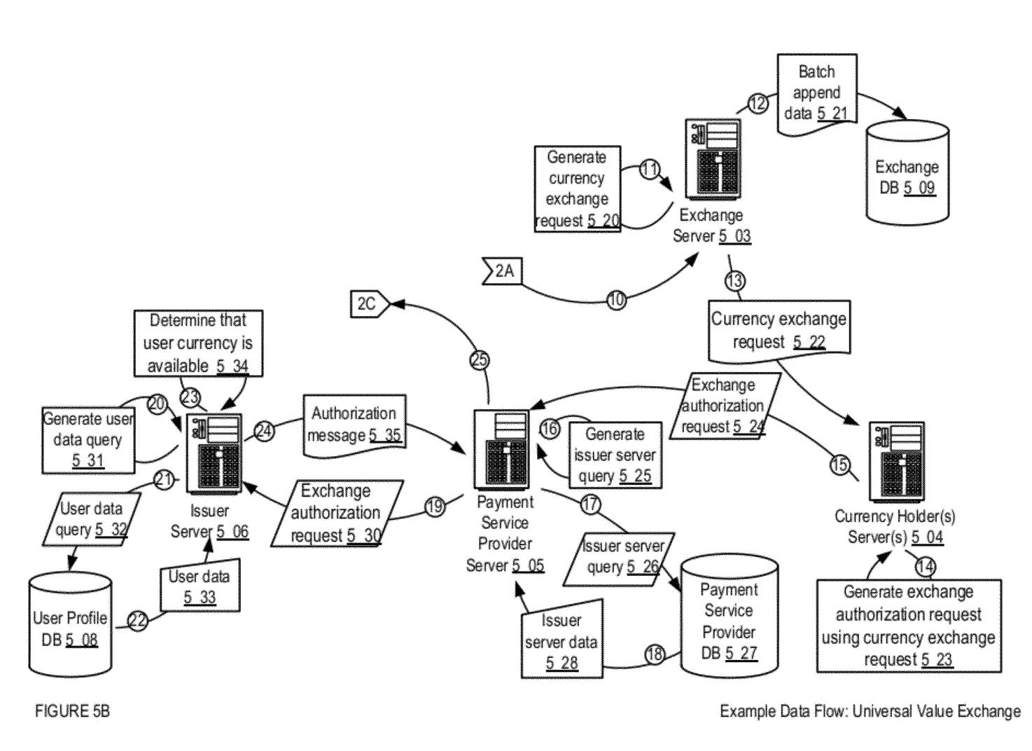

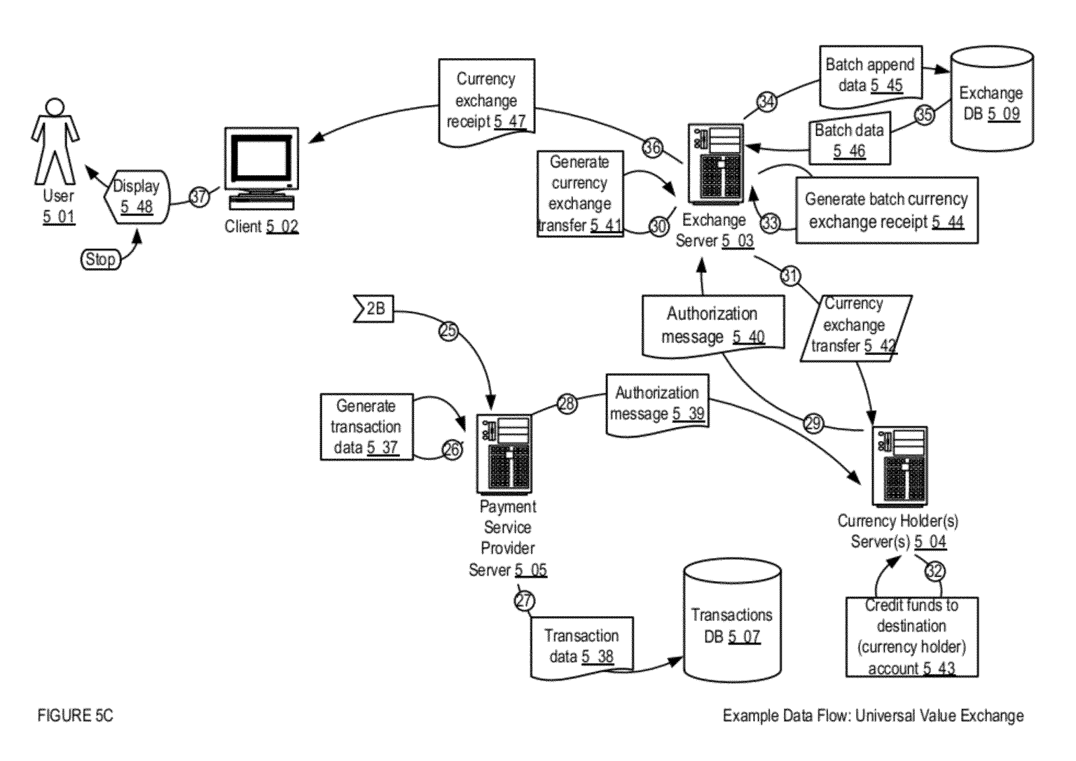

FIG. 5A-5D show a data flow diagrams illustrating example universal value exchange data flows within one embodiment of the LPS. In some implementations, a user may provide a currency exchange input 510 to a client device 502, and the client device may generate currency exchange instructions 511 which may be transmitted to the exchange server (e.g., LPS server) 512. In some implementations the exchange server 503 may parse the received instructions 513 to determine source and destination data (e.g., user as the source, and merchant as the destination) to define the end points of the value exchange transfer. The LPS may generate a source batch data request and destination batch data request. The generated batch requests may be transmitted to corresponding currency holder servers 515 where the requested data may be transmitted back to the exchange server 517. The exchange server may parse the received batch data, identify currencies associated with the source and destination requests and determine currency valuation rates for the source and destination currencies 518. In some embodiments the currency valuation rates may be created in relation to a single mutual currency that may be defined by the exchange server and in some embodiments may be associated with the user's virtual wallet currency type, acting in some embodiments as an intermediate currency. For example, a value exchange is to be carried out between a merchant's US dollars and a users collection of various rewards and online points (e.g., airline rewards, credit card rewards, virtual game points, etc.) because there are a variety of the currencies involved in this exemplary exchange an LPS may convert all currencies to a single currency. That single currency may be selected from the variety of currencies between the merchant and the user, the single currency may be a common currency between the merchant and the user, and in some embodiments that single currency may a tertiary currency (i.e., the currency of the user's LPS managed value virtual currency account, LPS managed user wallet).

In some embodiments, the LPS may obtain exchange restrictions and identify currency issuers based upon the currency type, user location, merchant location, and/or the like 518. The LPS may also identify currency payment service providers associated with the currency type, user location, merchant location, and/or the like 518. In some embodiments the LPS may generate a currency exchange flow path and currency exchange request defined in accordance with the aforementioned identified currencies, currency issuers, currency payment service providers and determined valuation rates 519, 520. In some embodiments the generated currency exchange request 522 may be transmitted to previously identified currency holder server(s) 504. The currency holder server(s) may generate an exchange authorization request 523 and transmit the exchange authorization request to the payment service provider server 524. In some embodiments, issuer server data may be requested from a payment service provider database 525-528. The payment service provider may request an authorization request from predetermined issuer servers 530-535 and may generate transaction data 537 which may be stored 538. Upon receipt of an authorization message 539 LPS may carry out the currency exchange transfer between currency holders and may provide receipt of the currency exchange to the user 539-548.

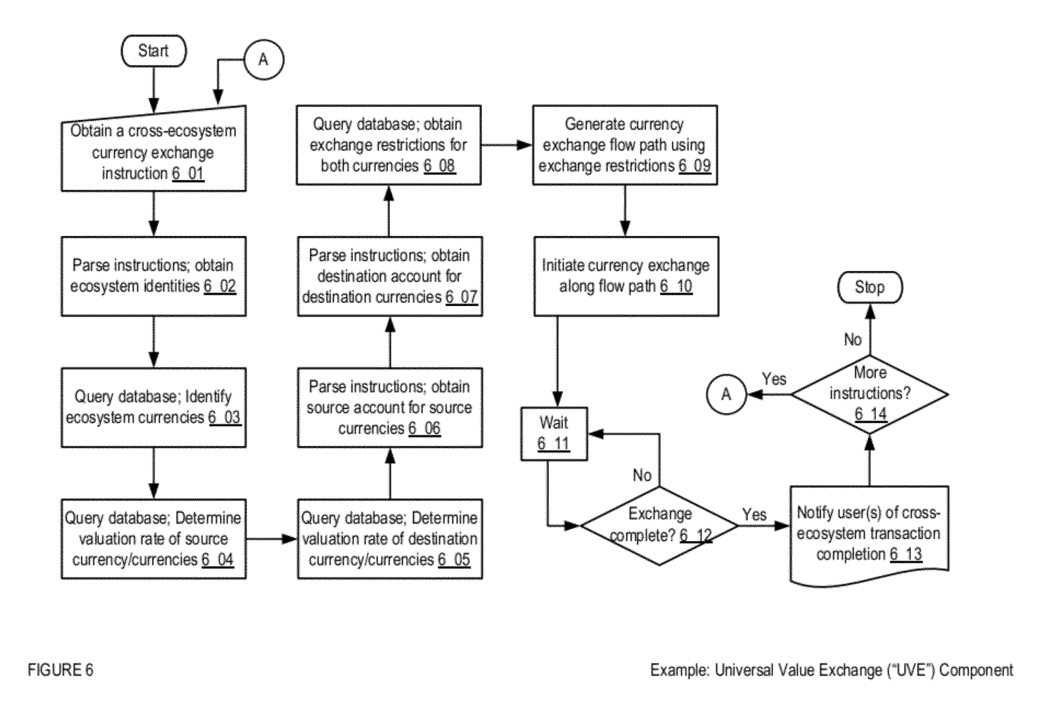

FIG. 6 shows a logic flow diagram illustrating exemplary aspects of transforming value equivalent exchange instructions into cross-ecosystem currency exchanges in some embodiments of the LPS. In some implementations, a universal value exchange controller may obtain one or more cross-ecosystem currency exchange instructions, e.g., 601. For example, such instructions may specify currency source details and currency destination details such as those discussed above. The universal value exchange controller may parse the obtained instructions, and determine the identities of the ecosystems acting as sources and destinations of the currencies, e.g., 602. The universal value exchange controller may utilize the identities of the source sand destination ecosystems to determine the currency types associated with each of the source and destination currency ecosystems, e.g., 603. Using the currency types, the universal value exchange controller may determine an exchange rate of each of the source and destination currencies relative to a standard currency, e.g., 604. For example, the universal value exchange controller may look up the currency exchange rates of the currency types of the currency sources in a relational database using a hypertext preprocessor (PHP) script utilizing Structured Query Language (SQL) commands. In some implementations, the universal value exchange controller may similarly determine the currency exchange rates of the currency types of the currency destinations, e.g., 605. In some implementations, the universal value exchange controller may parse the cross-ecosystem currency exchange instructions, and obtain account information (e.g., account name, account number, routing number, password, security codes, CVV number, etc.) for the source currencies, e.g., 606. For example, the universal value exchange controller may utilize such information to obtain access to the purchasing power retained in the currency sources. In some implementations, the universal value exchange controller may parse the cross-ecosystem currency exchange instructions, and obtain account information for the destination currencies, e.g., 607. For example, the universal value exchange controller may utilize such information to obtain access to the currency destinations for depositing purchasing power into the currency destinations.

In some implementations, the universal value exchange controller may also determine whether there are any restrictions and/or conditions at each of the sources of the currencies, as well as the destinations of the currencies. For example, the universal value exchange controller may query a database to obtain the restrictions and/or conditions for the sources and/or destinations. In some implementations, the universal value exchange controller may generate, e.g., 609, a currency exchange flow path based on the restrictions and/or conditions at the currency sources and/or destinations. Upon generating the currency exchange flow path, the universal value exchange controller may initiate currency exchange along the generated currency exchange flow path, for example, by providing request messages to the components in the currency exchange flow path to provide and/or accept currency value, based on the generated currency exchange flow path. The universal value exchange controller may monitor the currency exchange flow among the components in the currency exchange flow path until the currency exchange is complete, e.g., 611-612. Upon completing the currency withdrawal and/or deposits into each of the currency accounts involved in the cross-ecosystem currency exchange, the universal value exchange controller may provide notifications, e.g., 613, for the users of the universal value exchange controller notifying them of completion of the requested cross-ecosystem currency transaction. In some implementations, the universal value exchange controller may determine whether there are more cross-ecosystem currency exchange instructions remaining to be processed (e.g., 614, option “Yes”), and perform the cross-ecosystem currency exchanges until all the cross-ecosystem currency exchange instructions have been processed (e.g., 614, option “No”).

### LPS Controller

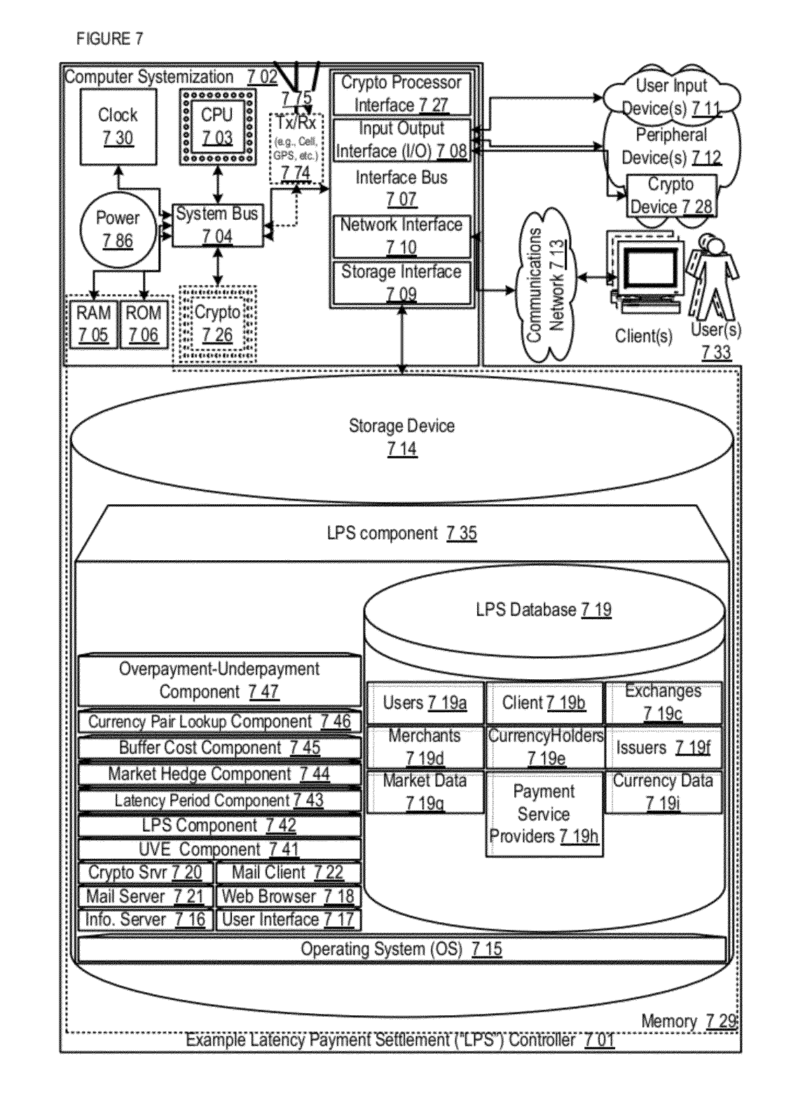

FIG. 7 shows a block diagram illustrating embodiments of a LPS controller. In this embodiment, the LPS controller 701 may serve to aggregate, process, store, search, serve, identify, instruct, generate, match, and/or facilitate interactions with a computer through payment and electronic commerce technologies, and/or other related data.

Typically, users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to allows various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system allows and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the LPS controller 701 may be connected to and/or communicate with entities such as, but not limited to: one or more users from user input devices 711; peripheral devices 712; an optional cryptographic processor device 728; and/or a communications network 713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The LPS controller 701 may be based on computer systems that may comprise, but are not limited to, components such as: a computer systemization 702 connected to memory 729.

### Computer Systemization

A computer systemization 702 may comprise a clock 730, central processing unit (“CPU(s)” and/or “processor(s)” (these terms are used interchangeable throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother)board(s) 702 having conductive and/or otherwise transportive circuit pathways through which instructions (e.g., binary encoded signals) may travel to effectuate communications, operations, storage, etc. The computer systemization may be connected to a power source 786; e.g., optionally the power source may be internal. Optionally, a cryptographic processor 726 and/or transceivers (e.g., ICs) 774 may be connected to the system bus. In another embodiment, the cryptographic processor and/or transceivers may be connected as either internal and/or external peripheral devices 712 via the interface bus I/O. In turn, the transceivers may be connected to antenna(s) 775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing LPS controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the LPS controller and beyond through various interfaces. Should processing requirements dictate a greater amount speed and/or capacity, distributed processors (e.g., Distributed LPS), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the LPS may be achieved by implementing a microcontroller such as CAST's R8051XC2 microcontroller; Intel's MCS 51 (i.e., 8051 microcontroller); and/or the like. Also, to implement certain features of the LPS, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the LPS component collection (distributed or otherwise) and/or features may be implemented via the microprocessor and/or via embedded components; e.g., via ASIC, coprocessor, DSP, FPGA, and/or the like. Alternately, some implementations of the LPS may be implemented with embedded components that are configured and used to achieve a variety of features or signal processing.

Depending on the particular implementation, the embedded components may include software solutions, hardware solutions, and/or some combination of both hardware/software solutions. For example, LPS features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the LPS features. A hierarchy of programmable interconnects allow logic blocks to be interconnected as needed by the LPS system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the LPS may be developed on regular FPGAs and then migrated into a fixed version that more resembles ASIC implementations. Alternate or coordinating implementations may migrate LPS controller features to a final ASIC instead of or in addition to FPGAs. Depending on the implementation all of the aforementioned embedded components and microprocessors may be considered the “CPU” and/or “processor” for the LPS.

### Power Source

The power source 786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the LPS thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

### Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like. Network interfaces 710 may accept, communicate, and/or connect to a communications network 713. Through a communications network 713, the LPS controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11B-x, and/or the like. Should processing requirements dictate a greater amount speed and/or capacity, distributed network controllers (e.g., Distributed LPS), architectures may similarly be employed to pool, load balance, and/or otherwise increase the communicative bandwidth required by the LPS controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11B/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 712 may be connected and/or communicate to I/O and/or other facilities of the like such as network interfaces, storage interfaces, directly to the interface bus, system bus, the CPU, and/or the like. Peripheral devices may be external, internal and/or part of the LPS controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the LPS controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the LPS controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the LPS controller and/or a computer systemization may employ various forms of memory 729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 729 may contain a collection of program and/or database components and/or data such as, but not limited to: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); the LPS component(s) 735; and/or the like (i.e., collectively a component collection). These components may be stored and accessed from the storage devices and/or from storage devices accessible through an interface bus. Although non-conventional program components such as those in the component collection, typically, are stored in a local storage device 714, they may also be loaded and/or stored in memory such as: peripheral devices, RAM, remote storage facilities through a communications network, ROM, various forms of memory, and/or the like.

### Operating System

The operating system component 715 is an executable program component facilitating the operation of the LPS controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may allows the interaction with communications networks, data, I/O, peripheral devices, program components, memory, user input devices, and/or the like. The operating system may provide communications protocols that allow the LPS controller to communicate with other entities through a communications network 713. Various communication protocols may be used by the LPS controller as a subcarrier transport mechanism for interaction, such as, but not limited to: multicast, TCP/IP, UDP, unicast, and/or the like.

### Information Server

An information server component 716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the LPS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the LPS database 719, operating systems, other program components, user interfaces, Web browsers, and/or the like.

Access to the LPS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the LPS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the LPS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the LPS enabled nodes. The combined application may be nugatory on systems employing standard Web browsers.

### Mail Server

A mail server component 721 is a stored program component that is executed by a CPU 703. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the LPS.

Access to the LPS mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by a CPU 703, cryptographic processor 726, cryptographic processor interface 727, cryptographic processor device 728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the LPS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to allow the LPS component to engage in secure transactions if so desired. The cryptographic component facilitates the secure accessing of resources on the LPS and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The LPS Database

The LPS database component 719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the LPS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the LPS database is implemented as a data-structure, the use of the LPS database 719 may be integrated into another component such as the LPS component 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 719 includes several tables 719a-i. A User table 719a may include fields such as, but not limited to: user_id, ssn, dob, first_name, last_name, age, state, address_firstline, address_secondline, zipcode, devices_list, contact_info, contact_type, alt_contact_info, alt_contact_type, UserIncome, UserBankAccount, UserPreference, UserTransactionID, UserMobileID, UserSubcription, PreferredPaymentMethod, user_currency_id, user_currency_type, and/or the like. The user table may support and/or track multiple entity accounts on a LPS. A Clients table 719b may include fields such as, but not limited to: user_id, client_id, client_ip, client_type, client_model, operating_system, os_version, and/or the like. An Exchanges table 719c exchange_id, exchange_type, user_id, payment_id, payment_type, payment_currency, user_currency_id, merchant_currency_id, user_currency_type, merchant_currency_type, buffer_type, buffer_cost, consumer_percentage_cover_percent_value, option_id, option_cost, latency_id, latency_period, user_accountbalance, exchangepair_id, exchangepair_rate and/or the like. A Merchant table 719d includes fields such as, but not limited to: MerchantID, MerchantName, MerchantType, MerchantTerminalID, MerchantAddress, MerchantGPS, MerchantURL, MerchantTransactionID, merchant_currency, payment_id, payment_type, user_id, merchant_currency_type, merchant_currency_id, and/or the like. An Currency Holders table 719e includes fields such as, but not limited to: currencyholder_id, currencyholder_name, currencyholder_address, ip_address, mac_address, auth_key, port_num, security_settings_list, user_id, user_accountbalance and/or the like. An Issuers table 719f may include fields such as, but not limited to: issuer_id, issuer_name, issuer_address, ip_address, mac_address, auth_key, port_num, security_settings_list, and/or the like. A Market data table 719g includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An Payment Service Providers table 719h includes fields such as, but not limited to: user_id, payment_id, payment_amount, payment_type, issuer_id, issuer_name, issuer_address, ip_address, mac_address, auth_key, port_num, security_settings_list, and/or the like. An Currency Data table 719i includes fields such as, but not limited to: currency_id, currency_type, payment_id, exchangepair_id, exchangepair_rate.

In one embodiment, the LPS database may interact with other database systems. For example, employing a distributed database system, queries and data access by search LPS component may treat the combination of the LPS database, an integrated data security layer database as a single database entity.

In one embodiment, user programs may contain various user interface primitives, which may serve to update the LPS. Also, various accounts may require custom database tables depending upon the environments and the types of clients the LPS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 719a-i. The LPS may be configured to keep track of various settings, inputs, and parameters via database controllers.

The LPS database may communicate to and/or with other components in a component collection, including itself, and/or facilities of the like. Most frequently, the LPS database communicates with the LPS component, other program components, and/or the like. The database may contain, retain, and provide information regarding other nodes and data.

### The LPSs

The LPS component 735 is a stored program component that is executed by a CPU. In one embodiment, the LPS component incorporates any and/or all combinations of the aspects of the LPS that were discussed in the previous figures. As such, the LPS affects accessing, obtaining and the provision of information, services, transactions, and/or the like across various communications networks.

The LPS transforms inputs (e.g., latency payment requests, payment method selections, payments, value exchange instructions, and/or the like) and transform the inputs via various LPS components such as UVE component 741, LPS component 742, Latency Period Component 743, Market Hedge Component 744, Buffer Cost Component 745, Currency Pair Lookup Component 746, and/or the like into outputs (e.g., latency payment requests, payments, cross-ecosystem currency exchanges and/or the like).

The LPS component allowing access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the LPS server employs a cryptographic server to encrypt and decrypt communications. The LPS component may communicate to and/or with other components in a component collection, including itself, and/or facilities of the like. Most frequently, the LPS component communicates with the LPS database, operating systems, other program components, and/or the like. The LPS may contain, communicate, generate, obtain, and/or provide program component, system, user, and/or data communications, requests, and/or responses.

### Distributed LPSs

The structure and/or operation of any of the LPS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the LPS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the LPS controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
          $input = “”;
          $input = socket_read($client, 1024);
          $data .= $input;
} while($input != “”);
// parse data to extract variables
$obj = json_decode($data, true);
// store input data in a database
mysql_connect(″201.408.185.132″,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for LATENCY PAYMENT SETTLEMENT APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a LPS individual and/or enterprise user, database configuration and/or relational model, data type, data transmission and/or network framework, syntax structure, and/or the like, various embodiments of the LPS, may be implemented that allow a great deal of flexibility and customization. For example, aspects of the LPS may be adapted for virtual currency exchanges. While various embodiments and discussions of the LPS have been directed to payment and ecommerce systems, however, it is to be understood that the embodiments described herein may be readily configured and/or customized for a wide variety of other applications and/or implementations.

What is claimed is:

1. A latency payment settlement processor-implemented method to transform a latency payment method request into a latency payment, comprising:
obtaining latency payment method request having: a consumer specified payment method, a consumer currency type, a merchant currency type, and a merchant item currency amount;
determining a latency payment period associated with the latency payment method request;
determining a latency buffer amount based on the latency payment method request and the latency payment period;
generating a latency payment request by summing the latency buffer amount to the merchant item currency amount and structuring the summed amounts according to the latency payment period; and
providing the latency payment request.

2. The method of claim 1, wherein determining a latency payment period comprises:
determining an average payment provider remittance time based on the payment consumer specified payment method;
determining an average user payment remittance time based on the payment consumer specified payment method;
determining an efficiency point between the average payment provider remittance time and the average user payment remittance time; and
generating the latency payment period based on the efficiency point.

3. A latency payment settlement processor-implemented method to transform a latency payment method request into a latency payment request, comprising:
obtaining latency payment method request having: a consumer specified payment method, a consumer currency type, a merchant currency type, and a merchant item currency amount;
determining a latency payment period associated with the latency payment method request;
determining a consumer item currency amount by applying a currency conversion factor to the merchant item currency amount;
determining a latency buffer amount based on the latency payment method request and the latency payment period;
generating a latency payment request by summing the latency buffer amount to the consumer item currency amount and structuring the summed amounts according to the latency payment period; and
providing the latency payment request.

4. The method of claim 3, wherein determining a latency payment period comprises:
determining an average payment provider remittance time based on the payment consumer specified payment method;
determining an average user payment remittance time based on the payment consumer specified payment method;
determining an efficiency point between the average payment provider remittance time and the average user payment remittance time; and
generating the latency payment period based on the efficiency point.

5. The method of claim 3, wherein the latency payment request is provided to the merchant.

6. The method of claim 3, wherein the latency payment request is provided to the consumer.

7. The method of claim 3, wherein the latency buffer amount is a factor obtained by looking up payment provider tables that contain factors for remittance times and processing costs.

8. The method of claim 7, wherein the payment provider tables are determined from the consumer specified payment method.

9. The method of claim 3, further comprising obtaining consumer payment in response to the provided latency payment request.

10. The method of claim 9, further comprising:
cancelling the latency payment request if the consumer payment is not obtained within the latency payment period; and
storing the consumer payment.

11. The method of claim 9, further comprising:
providing payment to the merchant benefiting from the latency buffer amount if the consumer payment is obtained within the latency payment period.

12. The method of claim 11, further comprising comparing the consumer payment to the latency payment request by determining a value difference between the consumer payment and the latency payment request.

13. The method of claim 11, further comprising:
storing the value difference if the consumer payment is greater than the latency payment request; and
providing an overpayment message based upon the stored value difference.

14. The method of claim 11, further comprising:
generating an underpayment request based upon the value difference if the consumer payment is less than the latency payment request; and providing the underpayment request.

15. The method of claim 3, wherein determining a consumer item currency amount further comprises:
obtaining a currency conversion factor between a merchant currency type and a consumer currency type.

16. The method of claim 15, wherein the merchant currency type and the consumer currency type are the same and the currency conversion factor is 1.

17. The method of claim 3, wherein the latency buffer amount is a factor obtained by looking up a latency currency conversion pairs table that contains factors for currency pairs.

18. The method of claim 17, wherein the latency currency conversion pairs table values are determined from statistical currency pair fluctuations.

19. The method of claim 3, wherein the latency buffer amount is determined by obtaining a merchant payment currency option to purchase a merchant payment currency of the merchant currency type in the amount of the merchant item currency amount having a strike date at least related to the latency payment period.

20. The method of claim 19, further comprising:
obtaining consumer payment in response to the provided latency payment request;
exercising the merchant payment currency option; and
providing payment to the merchant benefiting from the exercise of the merchant payment currency option.

21. The method of claim 3, wherein the latency buffer amount includes a merchant payment currency option.

22. The method of claim 21, wherein the latency buffer amount includes a factor obtained by looking up a latency currency conversion pairs table that contains factors for currency pairs.

23. The method of claim 3, wherein the latency payment request comprises:
a quoted amount that is valid for a fixed period of time, wherein the fixed period of time is equal to the latency payment period, wherein the quoted amount is related to risk associated with the consumer specified payment method.

24. The method of claim 23, wherein the risk associated with the consumer specified payment method comprises volatility of the consumer currency type, user payment frequency, and payment provider remittance time.

25. The method of claim 10, wherein latency payment request is provided online and the consumer payment is obtained offline.

26. The method of claim 25, wherein the latency payment request is associated with a voucher coupon and voucher coupon amount.
